(19) United States
(12) Patent Application Publication
(10) Pub. No.: US 2008/0275813 A1
(43) Pub. Date: Nov. 6, 2008

(54) Systems and Methods to Provide Connections for Real Time Communications and Commerce

(75) Inventors: Ebbe ALTBERG, Mill Valley, CA (US); Scott FABER, San Francisco, CA (US); Ron HIRSON, San Francisco, CA (US); Sean VAN DER LINDEN, Berkeley, CA (US); Paul G. MANCA, Oakland, CA (US)

Correspondence Address: GREENBERG TRAURIG, LLP (SV4), IP DOCKETING, 2450 COLORADO AVENUE SUITE 400E, SANTA MONICA, CA, 90404, US

(73) Assignee: UTBK, INC., Dover, DE (US)

(21) Appl. No.: 11/770,644

(22) Filed: Jun. 28, 2007

Related U.S. Application Data
(60) Provisional application No. 60/915,915, filed on May 3, 2007.

(51) Int. Cl. G06Q 40/00

(52) U.S. Cl. 705/39

(57) ABSTRACT

Systems and methods to connect a seller to a customer according to a request received from the seller. One embodiment includes a session border controller to interface with a packet switched network, and one or more servers coupled to the session border controller to receive from a seller a request for a connection to a customer for real time communications between the seller and the customer, to establish the connection for real time communications between the seller and the customer in response to the request received from the seller, to identify payment information of the customer, and to charge the customer on behalf of the seller using the payment information for a transaction made over the connection established in response to the request received from the seller.

### CROSS-REFERENCE TO RELATED APPLICATION

The present application claims the priority from Provisional U.S. Patent Application Ser. No. 60/915,915, filed May 3, 2007 and entitled “Systems and Methods to Provide Connections for Real Time Communications and Commerce,” the disclosure of which is hereby incorporated herein by reference.

### FIELD OF THE TECHNOLOGY

At least some embodiments of the disclosure relate to user interface techniques to assist people to connect for real-time communication, such as connecting people for telephonic conversation, chat, document sharing, screen-sharing, etc.

### BACKGROUND

Internet, cellular communication systems, television, newspaper, etc., provide diverse communication media channels through which people may receive information and/or communicate with each other.

For example, telephone systems allow users to conduct real time two-way voice communications. Traditional land-line based telephone systems connect one telephone set to another through one or more switching centers, operated by one or more telephone companies, over a land-line based telephone network. Traditionally, a telephone connection is based on a circuit switched network.

Current telephone systems can also use a packet-switched network for a telephone connection. A packet switched network is typical in a computer data environment. Technologies developed in the field of Voice over IP (VoIP) allow the delivery of voice information using the Internet Protocol, in which voice information is packaged in discrete packets in a digital form, rather than in the traditional circuit-committed protocols of the public switched telephone network (PSTN).

Cellular networks allow a cellular phone to connect to a nearby cellular base station through an air interface for wireless access to a telephone network. Current wireless telephone systems allow not only voice communications but also data communications. For example, cellular phones can receive and send messages through a Short Message Service (SMS), or a Multimedia Message Service (MMS). Web pages can be retrieved through wireless cellular links and displayed on cellular phones. Wireless Application Protocol (WAP) has been developed to overcome the constraints of relatively slow and intermittent nature of wireless links to access information similar or identical to World Wide Web.

Internet can be used to present the listings of experts or advisor's to customers. The customers may use the listings to request for connections with selected experts or advisor's. For example, Walker et el. (U.S. Pat. No. 5,862,223) discloses an expert matching system for managing communications between an expert having particular qualifications and an end user seeking a solution to an expert request. For example, Lauffer (U.S. Pat. No. 6,223,165) discloses a server unit which can store and display the names and characteristics of experts and then rapidly assist in connecting the expert and consumer for real-time communication.

### SUMMARY OF THE DESCRIPTION

Systems and methods to connect a seller to a customer according to a request received from the seller are described herein. Some embodiments are summarized in this section.

One embodiment includes a session border controller to interface with a packet switched network, and one or more servers coupled to the session border controller to receive from a seller a request for a connection to a customer for real time communications between the seller and the customer, to establish the connection for real time communications between the seller and the customer in response to the request received from the seller, to identify payment information of the customer, and to charge the customer on behalf of the seller using the payment information for a transaction made over the connection established in response to the request received from the seller.

In one embodiment, a method includes receiving from a seller a request for a connection to a customer for real time communications between the seller and the customer; responsive to the request received from the seller, establishing the connection for real time communications between the seller and the customer; identifying payment information of the customer; and charging the customer on behalf of the seller using the payment information for a transaction made over the connection established in response to the request received from the seller.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIGS. 1A-1C illustrate systems to connect a seller to a customer according to some embodiments.

FIG. 2 illustrates an interface to be used by a seller to initiate a call to a customer according to one embodiment.

FIG. 3 illustrates an interface to be used by a seller to initiate a fee-based period of real time communications with a customer according to one embodiment.

FIG. 4 illustrates an interface to be used by a customer to accept the charge requested by the seller according to one embodiment.

FIG. 5 illustrates an interface to be used by a customer to request a real time communication session with a seller according to one embodiment.

FIG. 6 illustrates an interface to be used by a seller to select a customer from a queue for real time communications according to one embodiment.

FIG. 7 illustrates a method to connect a seller to a customer in response to a request received from the seller according to one embodiment.

FIG. 8 shows a system including a connection server configured on a packet switched network according to one embodiment.

FIG. 9 shows a connection server according to one embodiment.

FIG. 10 shows a data processing system according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

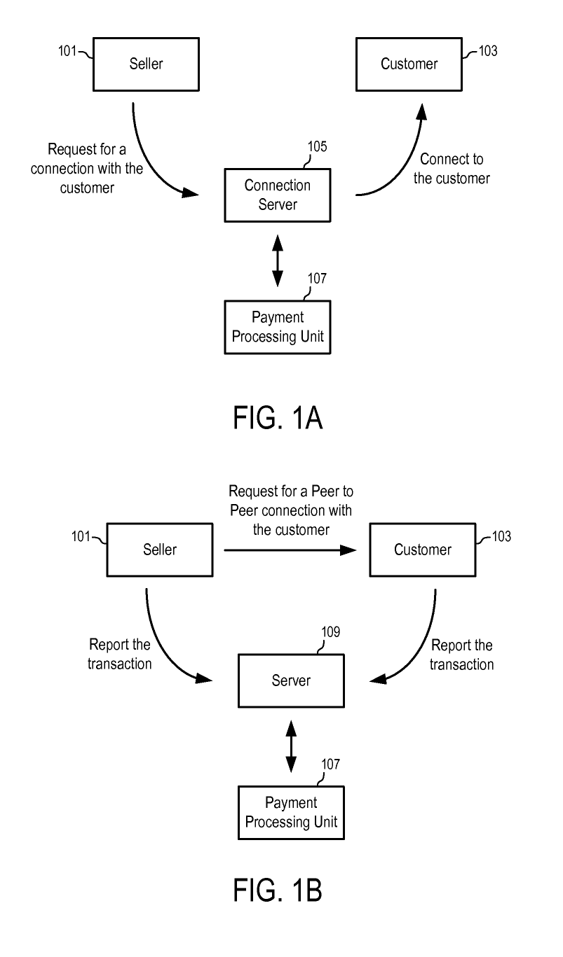

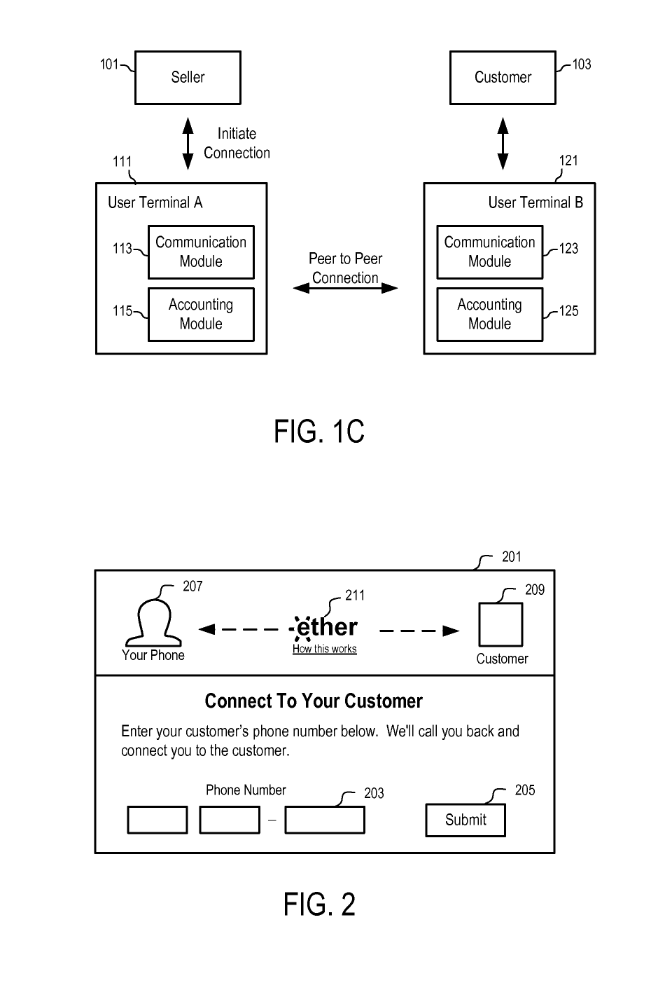

FIGS. 1A-1C illustrate systems to connect a seller to a customer according to some embodiments. In FIGS. 1A-1C, the seller (101) can initiate a connection with a customer (103) for real time communications.

One embodiment allows a seller to request a connection provider to make a connection between the seller and a buyer for real time communications and to charge the buyer on behalf of the seller, as illustrated in FIG. 1A.

In FIG. 1A, a connection server (105) allows a seller (101) to request the connection server (105) to provide a connection between the seller (101) and the customer (103). Once connected to the customer (103), the seller (101) can request the connection server (105) to start charging the customer (103) using the payment processing unit (107) that is coupled with the connection server (105).

In FIG. 1A, the seller (101) can make the request for the connection via dialing a telephone number, or initiating a call from a web page, or selecting a link for a request for a callback from the connection server (105) to the seller (101), or sending the connection server (105) an SMS message, an email, an instant message, etc. for a callback to the seller (101), etc.

The seller (101) may identify the customer (103) via specifying the telephone number of the customer (103) over the phone connection between the seller (101) and the connection server (105), or specify a reference assigned by the connection server (105) to the customer (103) in the request, or calling the connection server (105) using a phone number assigned to the customer, or using a click-to-call reference assigned to the customer, or using a click-to-call reference associated with both the seller (101) and the customer (103), or using a Session Initiation Protocol (SIP) address or Uniform Resource Identifier (URI) associated with the customer (103) (or associated with both the seller and the customer), or using other telephonic reference assigned to the customer and/or the seller. In one embodiment, a reference to the caller is provided to the user terminal of the seller and received back from the seller during the communication process of requesting for a connection with the customer. The reference can be provided in a call initiation message, in a call signaling message, in a callback request message, in a request for a telephonic reference of the customer, in address information of a message, in a header or body of the message, etc.

In one embodiment, a click-to-call reference includes a reference that is selectable in a browser to launch a softphone application to place a VoIP-based call, or selectable to request a server to initiate a callback process. For example, a link or icon displayed in a browser can be selected (e.g., clicked) via a cursor control device, such as a mouse, a touch pad, a track ball, a touch screen, etc. The selection of the link or icon can be designed to send a message to a server to initiate a callback to the user of the browser. In one embodiment, a click-to call reference can be provided to a softphone application for presentation on a user interface of the softphone application; and the click-to-call reference can be selected to cause the softphone application to establish telephonic connection according to the click-to-call reference. The softphone application may initiate the telephonic connection, or send a message to request a callback for the telephonic connection. A softphone application may be a standalone application or a built-in or plug-in module of a browser, or an applet provided in a web page presented in the browser.

In one embodiment, a click-to-call reference is associated with both the seller (101) and the customer (103). When the click-to-call reference is selected in a browser, the connection server (105) can identify the telephone references of both the seller (101) and the customer (103) and initiate calls to both the seller (101) and the customer (103) to provide a telephone connection. The telephonic references can be telephone numbers without extensions, telephone numbers with extensions, SIP URI, a user identifier of a VoIP or instant messaging network, a VoIP user identifier for a peer to peer network, an Internet address for a VoIP application, or other identifiers for the initiation of telephonic connections. For example, the click-to-call reference may be used in a database to look up the phone numbers of the seller (101) and the customer (103). Alternatively, the click-to-call reference includes an encoded or encrypted version of the telephonic references, which can be decoded or decrypted to provide the telephonic references of the seller (101) and the customer (103) without relying upon a database.

For example, after the customer (103) requests the connection server (105) to provide a connection between the seller (101) and the customer (103), the connection server (105) can present the customer's request to the seller (101) via a click-to-call reference embedded in a web page, an email message, an SMS message, or an instant message. The click-to-call reference is associated with both the seller (101) and the customer (103). Thus, the seller (101) can decide when to start the call; and the seller (101) can become the caller.

The seller (101) may charge the customer (103) for services rendered over the connection provided by the connection server (105). For example, the seller may provide information, entertainment, advice, consultation, amusement, etc. over the connection established by the connection server (105). The services may be charged according to the time period of the services.

In one embodiment, a fee-based time period for services provided by the seller (101) starts after an initial free time period of connection provided to the seller (101) and the customer (103). In another embodiment, once the customer (103) agrees, the entire time period of the connection provided by the connection server (105) is charged. Alternatively, the services may be charged based on a flat fee, or a fee independent of the time period of the conversation.

In one embodiment, the customer is charged a predetermined amount of fees for a time period that is within a predetermined length (e.g., 5 minutes, 20 minutes, 60 minutes, etc.). The customer may use the entire time period in the current connection, or use a portion of the purchased time period in the current connection and the remaining portion in the next connection. In one embodiment, the unused portion of a purchased time period expires after a predetermined time window (e.g., a day or a week). After the purchased time period expires, the customer may make another purchase to extend the connection, or pay in an ongoing basis (e.g., pay for each minute or 5 minutes, or 15 minutes). In another embodiment, the customer may be charged an amount for an estimated time needed; the estimated time period may be specified by the customer; and the unused portion of the purchase is refunded to the customer after the connection between the customer and the seller is disconnected.

In one embodiment, the fee-based time period of the connection is explicitly specified by the seller (101) and/or the customer (103). For example, the fee-based time period may be started by the customer's indication of acceptance and stopped by the customer (103) or the seller (101). In one embodiment, another fee-based time period may be started after a free time period following a fee-based time period.

In one embodiment, the seller (101) may charge the customer (103) for physical goods purchased by the customer via the connection provided by the connection server, such as a book, a computer, etc.

The price for charging the customer (103) may be pre-determined according to the listing of the seller (101), or be specified by the seller (101) during the request for the connection, or be specified by the seller (101) after the seller (101) requests the connection server (105) to charge the customer (103).

For example, after the seller (101) and the customer (103) are connected by the connection server (105) for a telephone conversation, the seller (101) may press a “#” key to request the payment processing unit (107) to charge the customer (103) according to the price specified in the listing of the seller (101). Alternatively, after the seller (101) presses the “#” key, the seller is connected to a human operator or an interactive voice response (IVR) system to specify the price. Alternatively, the seller (101) may press the sequence “#500*” to request the payment processing unit (107) to charge the customer (103) at the rate of $5.00 per minute. In response to the request from the seller (101), the connection server (105) can connect the customer (103) to a human operator or an IVR system to obtain the payment information, and/or to confirm the acceptance of the charge. For example, when the telephonic apparatuses of the seller and customer have graphical user interfaces or when graphical user interfaces are provided in association with the telephonic connection, the seller and the customer can use the graphical user interfaces to initiate the payment request, to specify the price, to accept or decline the payment request, etc. For example, when softphones are used by the seller and the customers, the payment process can be facilitated via the graphical user interface of the softphone. For example, when a web interface is used for the seller to request a callback for the connection, the web interface can be used to initiate the payment request and specify the price. When a web interface is available to the customer, the customer may use the web interface to reject or accept the payment request. For example, the customer selects a link or icon button presented on the softphone of the customer to activate the web interface; alternatively, the softphone of the customer may invoke a web browser to introduce a web interface for the connection; alternatively, the customer may separately launch a web browser in response to the connection and visit a web site to access web pages associated with the connection.

In one embodiment, the customer is authenticated prior to being connected to the seller. For example, in response to receiving from the seller (101) the request for a connection to the customer, the connection server (105) may call the customer (103), obtain the payment information from the customer (103), and then connect the customer (103) to the seller (101).

In one embodiment, when the contact information of the customer (103) is provided by the seller (101), the connection server (105) connects the customer (103) and the seller (101) for a free time period of conversation; and the customer (103) is asked to identify the payment information after the seller (101) requests the connection server (105) to start charging the customer. When the contact information of the customer (103) is not provided by the seller (101) (e.g., when the seller requesting a connection to a customer obtained by the connection server), the connection server (105) obtains the payment information of the customer prior to connecting the customer (103) and the seller (101).

For example, Bob, an advisor, may call 1-800-My-Ether, sign into his account, and enter the telephone number of Sue, a potential client of Bob. The connection provider then calls the telephone number of Sue to connect Bob to Sue. When Sue picks up the phone, a free time period is started, which allows Bob to explain his rates and/or services. After Sue agrees, Bob can press “#” key (or an icon button or a link in a visual interface) to cause the connection provider to take Sue to an operator, an Interactive Voice Response (IVR) system, or a visual interface to collect payment information, such as a credit card number, a debit card number, a bank account number, a member identifier, a user name/password, etc.

Since Bob can initiate calls to his customers, Bob (seller) doesn't have to rely on the customers (e.g., Sue) calling him. For example, Bob can use the system to call existing clients to follow up with previous sessions of discussions or to call new clients developed by Bob himself, etc.

In another example, Bob is assigned the phone number 1-800-Call-Bob by the connection provider. Bob can provide the phone number 1-800-Call-Bob in his blog, email, business card, advertisements, etc., to receive calls from customers. When a customer calls the phone number 1-800-Call-Bob, the connection provider receives the call and further connects the call to Bob, after verifying that the call is received during the scheduled callable hours of Bob. For example, the connection provider can look up Bob's phone number based on the number 1-800-Call-Bob that was dialed by the customer and then further connect the received call to the Bob's phone number.

In one embodiment, Bob can also dial the phone number 1-800-Call-Bob, that is assigned to Bob to receive customer calls, to initiate a call to Sue via the connection provider. Once the connection provider detects that the call is received from Bob, the connection provider allows Bob to enter a telephone number of his customer to reach the customer. Thus, Bob can enter the phone number of Sue to request the connection provider to establish the telephone connection between Bob and Sue.

Alternatively, Bob can request a callback from the connection provider by selecting a web link or icon, sending an SMS message to the connection provider, or an instant message.

In one embodiment, the seller can use a given phone number (e.g., 1-800-Call-Bob or 1-800-My-Ether) to initiate calls back to the customer. For instance, a seller can receive a voicemail from a buyer who would like some information and has left his phone number to be called. The seller can reach this buyer by first dialing the phone number assigned to the seller (e.g., 1-800-My-Ether). The connection provider detects that the seller is calling from a phone number that is associated with the phone number dialed (e.g., 1-800-My-Ether), the connection provider connects the seller to an Interactive Voice Response (IVR) system to prompt the seller for a phone number of his customer. After the seller dials the phone number of the customer, the call received from the seller is connected to the customer. When the customer answers, the call is initially free, until the “#” key is pressed or other indicators (e.g., a voice command, a selection of a link or an icon button) is provided, which causes the payment processing unit to collect funds from the buyer and pay the seller.

Alternatively, the buyer can provide his phone number to the connection provider, instead of to the seller in the voicemail (e.g., for privacy reasons). In response to the voicemail, the seller can ask the connection provider to bridge the call from the seller to the buyer.

In one embodiment, the voicemail is maintained in the system of the connection provider in association with the phone number of the buyer. After a period of time, the customer/buyer may optionally ask the connection provider to cancel the voicemail, or block the seller from calling back to the buyer. The seller can check the voicemail and request the connection before the customer/buyer cancels the voicemail. In one embodiment, the customer/buyer can specify that the voicemail expires within a period of time.

Alternatively, the voicemail can be left on the answer machine of the seller, or a voicemail service of the seller that is not under the control of the connection provider. The seller can identify the buyer by specifying the date and time of the voicemail, or a reference added by the connection provider to the voicemail.

Alternatively, the reference can be provided to the telephonic apparatus of the seller (e.g., a softphone of the seller), which can be selected by the seller on the telephonic apparatus to initiate the call to the customer. Alternatively or in combination, the reference can be sent via an email message, an instant message, a web based message, an SMS message, etc.

For example, the connection provider may assign a reference number or identifier to the customer. After the seller dials a general access number (e.g., 1-800-My-Ether) or the phone number assigned to the seller (e.g., 1-800-Call-Bob), the connection provider can prompt the seller for the reference number or identifier that can be used by the connection provider to determine the callback phone number of the customer.

For example, the connection provider may assign a phone number (e.g., 1-800-Call-Sue) to the customer (e.g., Sue) and provide the phone number (e.g., 1-800-Call-Sue) to the seller (e.g., Bob) via a web page, an email, an instant message, an SMS or MMS message. The phone number may be valid to reach the customer within a time period specified by the customer. The seller can call the connection provider at the phone number assigned to the customer for a connection to the customer. In other embodiments, the connection provider can also assign other types of telephonic references to the customer (e.g., Sue), temporarily or for a pre-determined period of time or for an undetermined period of time, and provide the assigned telephonic reference to the seller (e.g., Bob). For example, the assigned telephonic references may use the extension to identify the customer (e.g., 1-800-Call-Now ext Sue, or 1-415-Call-New ext Sue4Bob), or use a SIP URI (e.g., sip:Sue_Bob ingenio.com), or use other types of references or identifiers.

In another embodiment, the system may present to the seller with a list of one or more customers who want to contact the seller via the connection provider. The list may be presented via a web page, an email, an instant message, an SMS or MMS message, a voice mail, etc. The seller can select a customer and request for a connection with the selected customer.

The seller (101) may use the connection server (105) to call for a connection for various types of real time communications, such as telephone conversation, chat in text, voice and/or video, instant messaging, application sharing, screen sharing, common whiteboarding, etc.

In one embodiment, the connection server (105) and the payment processing unit (107) are implemented as one or more centralized servers. The seller (101) and the customers (103) communicate with each other using telephonic apparatuses.

In one embodiment, a telephonic apparatus is a softphone implemented at least in part via software, such as an instant messenger, a VoIP client application running on a computer, an applet embedded in a web page, a built-in or plug-in module of a web browser, a handheld device, a personal digital assistant (PDA), a cellular phone, a cordless phone, a Bluetooth phone, a WiFi phone, etc. The telephonic apparatus may be designed to make a connection based on Internet Protocol, based on a peer to peer network, based on software, and/or based on a connection to a server or a host computer, etc. In some embodiments, the telephonic apparatus is implemented via hardwire circuitry, such Application-Specific Integrated Circuit (ASIC); in some embodiments, the telephonic apparatus is implemented partially via special purpose hardwire circuitry and partially via software, such as Application-Specific Integrated Circuit (ASIC) or Field-Programmable Gate Array (FPGA) with software/firmware; and in some embodiments, the telephonic apparatus is implemented using a set of general purpose hardwire components that are under the control of software. In some embodiment, a traditional, landline telephonic apparatus can also be used.

In some embodiments, the seller (101) and the customers (103) communicate with each other using user terminals for text, audio, and/or video based real time communications, such as text/voice/video chat, document sharing, screen-sharing, common whiteboarding, application sharing, via a communication network, such as a cellular telecommunication network, a local area network, a wide area network, a wireless local area network, an intranet, Internet, a public switched telephone network, etc. While many examples are illustrated for telephonic connections, the disclosure is not limited to telephonic communications.

In one embodiment, the functionality of the connection server (105) and the payment processing unit (107) are distributed in part, or in entirety, into the user terminals used by the seller (101) and/or the customer (103). The user terminals can make peer to peer communication connections without having to go through a centralized server, as illustrated in FIG. 1B.

In FIG. 1B, the user terminals of the seller (101) and the customer (103) make peer to peer connection to facilitate the communications while sending messages to a server (109) to facilitate payment processing. For example, the telephonic apparatus of the seller may initiate a peer to peer communication connection to the telephonic apparatus of the customer without a centralized connection server.

Alternatively, a reference sever can be used to provide the telephonic reference of the customer based on a reference received from the telephonic apparatus of the seller. For example, a reference can be assigned to a customer and provided to the seller for initiation of a real time communication connection to the customer; the reference received from the telephonic apparatus of the seller can be used to in a server to look up the telephonic reference of the customer from a database, or be decoded or decrypted to provide the telephonic reference of the customer; and the telephonic reference of the customer can then be used by the telephonic apparatus of the seller to make a peer to peer connection with the telephonic apparatus of the customer without going through a connection server.

In one embodiment, the payment processing functionality can be integrated into the user terminal (111) used by the seller (101) and/or the user terminal (121) used by the customer (103), as illustrated in FIG. 1C. The user terminals (e.g., softphones, cellular phones, PDAs, computers, standalone phones with data communication capability, web browsers, instant messaging applications, etc.) can be used to maintain the account information of the users and/or periodically report the account information to a service provider. In FIG. 1C, the communications modules (113 and 123) of the user terminals (111 and 121) can be used to make peer to peer connection for real time communications; and the accounting modules (115 and 125) can be used to facilitate payment processing without a centralized server.

For example, the accounting modules (115 and 125) of the user terminals (111 and 121) can perform transactions or record the transactions for subsequent updating in a centralized account database. In one embodiment, the account information of the members is maintained on a peer to peer network, with or without the help of a centralized account server.

For example, in one embodiment, the telephonic apparatus used by the customer (103) maintains the member account of the customer via the accounting module (125); and the telephonic apparatus used by the seller (101) maintains the member account of the seller via the accounting module (115). The telephonic apparatus (121) of the customer (103) pays the telephonic apparatus (111) of the seller (101) via the peer to peer communication connection between the telephonic apparatus of the customer (103) and the telephonic apparatus of the seller (101).

In one embodiment, during or after the communications between the customer and the seller, the telephonic apparatus of the customer and/or the telephonic apparatus can make a connection to a server of a service provider to provide a commission fee for the transaction to the service provider. In another embodiment, the commission fee is provided to the service provider via deduction of a portion of the balance from the accounting modules.

In one embodiment, a member account indicates the balances the member has through pre-paying the service provider. The balance may be in the unit of minutes for telecommunications (e.g., telephonic communication, instant messaging communications, etc.), in the unit of a currency (e.g., U.S. Dollar), or in the unit of points, etc. In one embodiment, the processing of the payment charged by the seller is in the form of transferring the member balance from one member account to another member account (e.g., via a peer to peer network or a centralized server). In one embodiment, a member account is maintained on a user terminal such as a computer, a PDA, or a telephonic apparatus (e.g., a softphone or a cellular phone, a WiFi phone, or a PDA based phone). In one embodiment, the member account can be dynamically transferred from being hosted on one user terminal to another terminal, via a peer to peer network or a server.

In another embodiment, the member account is maintained on a centralized server.

In one embodiment, the processing of collecting commission fee is in the form of deducting a portion of the balance from a member account, or transferring from a member account to an account of the service provider. In one embodiment, records of the transactions are stored to bill or credit the members via their telecommunication bills (e.g., telephone bills, cellular phone bills, etc.)

In one embodiment, a user terminal is configured to communicate with a financial institute to facility the transaction. For example, one user terminal may be configured to access a bank account of the member to make or receive payments; and another user terminal may be configured to make or receive payments via a credit card account, a debit card account, etc. The user terminals connected via a peer to peer connection may not use the same financial institute. In one embodiment, the user terminals are configured to use their respective associated financial accounts to automatically process the payment, after both the seller and the customer agree on the payment request.

FIG. 2 illustrates an interface to be used by a seller to initiate a call to a customer according to one embodiment. The interface can be implemented as a web page presented on a web browser, a user interface of a standalone application, a user interface of an applet or built-in/plug-in module of a browser, a user interface of a VoIP or instant messaging application, a user interface of a special purpose phone, a user interface of a programmable phone, etc. An interface having more or less elements than those illustrated in FIG. 2 can be implemented. In FIG. 2, the interface (201) has a call graphics which includes an iconic representation of the seller (207), an iconic representation of the connection provider (211) and an iconic representation of the customer (209). The call graphics can be used to graphically illustrate the connection process between the seller (207) and the customer (209).

In FIG. 2, the interface (201) allows the seller to specify a phone number of the customer in the entry box (203) and select the submit button (205) to request a connection between the seller and the customer. In response to the submitted request, the connection provider calls the seller and the customer separately and then connect the seller and the customer. In other embodiment, one or more entry boxes are provided to receive telephonic reference other than a telephone number without an extension. For example, the entry boxes can be used to specify a SIP URI of the customer, a telephone number with extension, a user identifier/member name, a VoIP user identifier for a peer to peer network, etc. In one embodiment, one or more telephonic references of the same or different types can be specified using the interface.

In one embodiment, a selection box can be used to select a listing from a plurality of listings of the seller as the topic of the call. Alternatively, the user interface (201) can be pre-associated with a listing of the seller. For example, a link or icon button that is selected to show the user interface (201) can have an embedded parameter that identifies the listing. In one embodiment, the listing provides a description of the offers of the seller and/or the price of the seller for the listing. In one embodiment, the seller is limited to charge the customer based on the listing. Alternatively, the price specified listing is used as a default price, which can be changed when the seller requests for payment.

In another embodiment, the interface also provides an entry box for the seller to specify a callback number (not shown in FIG. 2). In a further embodiment, the connection server identifies one or more phone numbers of the seller (e.g., based on prior callback numbers or a preference setting); and the seller can select one from the identified phone numbers or modified the identified phone numbers to specify the preferred callback number.

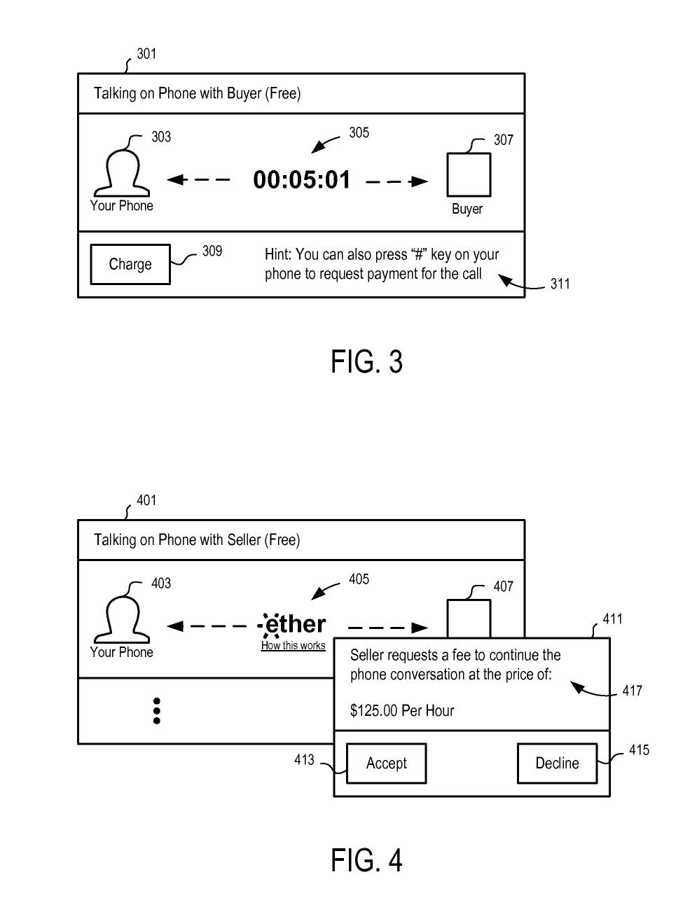

FIG. 3 illustrates an interface to be used by a seller to initiate a fee-based period of real time communications with a customer according to one embodiment. In FIG. 3, the interface (301) has a call graphics that includes an iconic representation of the seller (303), an iconic representation of the customer/buyer (307), and the current time duration of the connection (305).

In FIG. 3, the interface (301) includes the charge button (309) which can be selected by the seller to start the clock for charging the customer. The interface (301) also provides the hint that the seller pressed the “#” key on the phone to request payment for the call (or start the clock for charging the customer). Alternatively, the clock is started after the buyer accepts the payment request.

In one embodiment, the interface can also allow the seller to specify a price using an entry box or a selection box (not shown in FIG. 3) and/or an itemed to be sold to the customer. In one embodiment, the interface can also allow the seller to specify a listing fee (not shown in FIG. 3), which may be entered via an entry box or selected from a pre-determined list.

In one scenario, the connection server can provide a visual interface to the customer when contacting the customer. For example, the customer may be called via an instant messaging application for voice and data connection. For example, a web page or a link to a web page can be sent to the customer via email, instant messaging, SMS/MMS, etc. to show a visual interface to the customer.

FIG. 4 illustrates an interface to be used by a customer to accept the charge requested by the seller according to one embodiment. In FIG. 4, the interface (401) has a call graphics which includes an iconic representation of the seller (407), an iconic representation of the connection provider (405) and an iconic representation of the customer (403). A dialog box (411) is shown to indicate (417) that the seller requests a fee to continue the phone conversation at the price of $125.00 per hour.

If the customer selects the accept button (413), the connection provider charges the customer on behalf of the seller; and the connection between the seller and the customer is maintained.

If the customer selects the decline button (415), the customer is not charged; and the connection between the seller and the customer is disconnected. Alternatively, the seller is notified that the customer declines the request, while the connection between the seller and the customer is maintained; and the seller can decide to continue the communication without a fee (e.g., for another period of free time), to make another request with or without modifying the price, or to disconnect.

Alternatively or in combination, the customer can also be prompted for the acceptance of the charge via voice (e.g., through connecting the customer to an IVR system or a human operator).

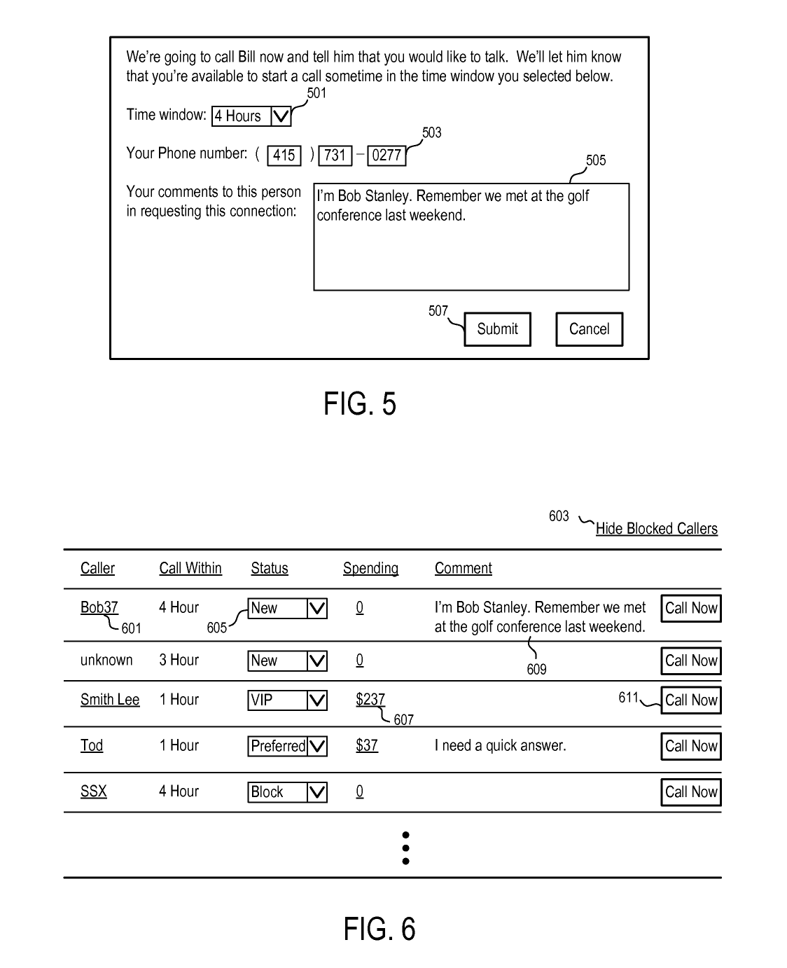

FIG. 5 illustrates an interface to be used by a customer to request a real time communication session with a seller according to one embodiment. In FIG. 5, the interface allows the customer to specify a time window (501) in which the customer is available for real time communications with the seller. The customer can provide the phone number of the customer in the entry box (503). In other embodiments, the customer can also provide other types of references for a real time communication, such as a member name, a user identifier, an account number, a screen name, a telephonic reference such as a SIP URI, a VoIP user ID, an instant messaging user identifier, etc.

In one embodiment, when the seller is available for real time communications with the customer, the connection provider can call the phone number of the customer to provide a connection between the customer and the seller.

In one embodiment, a reference to the customer request is provided to the seller to allow the seller to initiate the connection with the customer for real time communications.

In FIG. 5, the customer may further provide comment in the text field (505) to get the attention of the seller. For example, the customer may leave the following message to the seller “I'm Bob Stanley. Remember we met at the golf conference last weekend.” and then select the submit button (507) to submit the request.

In FIG. 5, a visual interface is provided to a customer to specify a callback number and a time window. Alternatively, the customer may call a phone number assigned to the seller to specify the callback number and the time window and to record a voice message for the seller. The phone number can be a phone number local to the customer, a toll free number (e.g., 1-800-Call-Bob), a telephone number with an extension, a SIP URI, an instant messaging user identifier, a VoIP user identifier, a user identifier of a peer to peer voice communication network, a member name, a click-to-call reference, a reference to a phone number, an Internet address for a voice connection, etc. When the phone number assigned to the seller is called by the customer, the call is connected to a connection provider which prompts the customer to specify a callback number, a time window, a voice message, if the seller is not immediately available to communicate with the customer.

In one embodiment, the connection provider presents the queue of customers waiting for the connection to the seller for real time communications. The seller can use the queue to initiate a call to a selected customer.

FIG. 6 illustrates an interface to be used by a seller to select a customer from a queue for real time communications according to one embodiment. In FIG. 6, a visual presentation of the queue is provided to allow the seller to sort the list of requesters.

In one embodiment, the system identifies the customers and then presents the customers using their member names (user ID for the system) without revealing their real names for the privacy of the customers. A customer may provide a public profile to the system. The information specified in the public profile of the customer can be presented by the system to other members of the system. Thus, the customer can selectively provide information in the public profile for a desired level of privacy.

Alternatively, the system may present the customers using identifiers that are generated specifically for the seller, to avoid revealing the member names of the customers for enhanced privacy protection. For example, a customer for the seller may be identified as “customer12,” while “customer12” for another seller may or may not be a reference to this customer and is generally not a reference to the same customer.

In one embodiment, the system also provides a tool to the seller to manage information. For example, in FIG. 6, when an identifier (e.g., 601) is selected by the customer, a further user interface (not shown) can be displayed to manage information about the customer as identified by the identifier. The seller may specify a name for the customer. For example, during the conversation with the customer, if the customer provides the name of the customer to the seller, the seller can record the name so that the customer can be subsequently identified using the name entered into the system by the seller. The seller may record a comment about the seller for subsequent viewing. The seller may provide a rank to the customer, load past transactions with the customer, and/or specify a status of the customer.

In one embodiment, the system identifies a first time customer to the seller as “new” (605). The customer may designate some customers as “VIP”, some customers as “Preferred”, some customers as “Blocked.” The customer may sort the customers according to their status.

In one embodiment, the system uses a social network to identify the customers. For example, customers can be identified by whether they're a “friend” or a “friend of a friend” in a social network.

For instance, a customer, Bob, might be identified as “2 degrees” away from a seller while Michael is “1 degree” away. Michael is a direct friend, whom the seller has certified as someone the seller knows, while Bob is a friend of a friend. For example, Bob might be a certified friend of Michael's. While the seller doesn't know Bob directly, Bob is in the extended network of the seller; and therefore the seller might want to talk to him. Cindy, on the other hand, might be “5 degrees” away.

The seller might have little interest in communicating with someone so far outside the social network of the seller. In one embodiment, the system allows sellers to individually certify friends, such that collectively the system maintains a social network, having data to identify friends of a friend, etc. Based on the social network, the system can compute the degrees of social separation between customers and the seller to allow the management of the customer queue using the degrees of social separation.

In one embodiment, the system also allows the customers to place bids to get priority in the queue. For example, when the customer requests the connection to the seller, the customer can also specify a bid amount for priority consideration. Thus, the order of customers in the queue can be at least partially determined by the amount that each customer is willing to pay for the priority.

For instance, a first customer, Aaron, is in line. Then, a second customer, Billy, indicates he will pay a lump sum of an additional 10 cents to be in front of him. Billy is now first in line, and Aaron is second. Carol, a third customer, indicates she will pay 40 cents, and now she is first. Aaron decides to pay 20 cents and now he is in second place and Billy is in third. Thus, the queue can be dynamic changed according to a live auction for place in line.

In one embodiment, the system can display a representation of the current queue to the customers to facilitate the auction of the priorities in the queue. For example, the system may inform a customer the current position of the customer and a list of current bids in the queue and allow the customer to modify his/her bid. The system may further provide estimated waiting times for the current queue to help the customer decide the bid.

In one embodiment, the seller may sort the queue based on the bids for priority and other considerations, such as the comments/introductions submitted with the requests, the seller's personal relation with the customers, prior transactions, etc. For instance, a seller (advisor) could see the payments that each customer is willing to make for an earlier position in line, but the seller (advisor) may still decide to take the call from his best friend Michael first, or move his highest-spending customer Cynthia to the top position. In one embodiment, the system presents the information to facilitate the decision making by the seller in sorting the queue.

In one embodiment, the system allows a customer to specify an upper limit of the amount for the bid and automatically calculate the bid for the customer to improve the priority of the customer. For example, the system can determine the least amount of bid that can beat as many of the bids of other customers as possible without exceeding the upper limit.

In one embodiment, the bid for priority is charged as a lump sum once the connection between the customer and the seller is established. Alternatively or in combination, the bids can be in the form of additional price per minute for the communication time with the seller, if the seller delivers service to the customer over the communication connection. For example, the seller may specify that the communication time with the seller is at least at a given price (e.g., $1.5 per minute). A customer may bid above the price (e.g., additional $0.2 per minute) to seek for priority. In one embodiment, the seller may specify the allowable bid formats (e.g., as a lump sum for priority or as additional fees per minute for priority in the queue). When different forms of bids are allowed, the system can further compute an estimated effective bid (e.g., based on an estimated communication time) to assist the seller.

Alternatively or in combination, the customer may sort the queue manually. In one embodiment, if the queue is sorted manually, an amount is charged according to the bid for priority if the position of the customer in the queue is improved because of the bid for priority, at the time the customer is connected to the seller. Alternatively, an amount is charged at the time the customer is connected to the seller according to the bid for priority even if the position of the customer in the queue did not improve because of the bid for priority. In one embodiment, a portion or the entire amount charged according to the priority is provided to the seller. In one embodiment, a portion or the entire amount charged according to the priority is provided to the connection provider.

In one embodiment, the list of customers include the links or icon buttons (e.g., 611) which can be selected by the seller to initiate a call to the customer. The links or icon buttons include click-to-call references that are associated with the seller and the respective customers. Once a link or icon button is selected, the connection provider can call both the seller and the customer to make the connection.

In one embodiment, the user can selectively show or hide the customers with the blocked status. For example, in FIG. 6 the blocked customers are listed; and the link (603) can be selected to request a list that does not show the blocked customers, together with a link that can be used to request a list that shows the blocked customers.

In FIG. 6, the remaining call back windows as requested by the customers are also displayed, together with the amount of past purchases (e.g., 607) from the respective customers, comments (e.g., 609) from the customers for the respective requests, etc. The remaining call back window indicates the time period between the time the list is generated and the time when the requested call back window expires. The information specific to the customers and/or the requests are provided to assist the seller in managing the customer queue. More or less information can be displayed with the queue in different embodiments. In one embodiment, the items to be displayed with the queue is configurable by the customer (e.g., via a preference page).

The interface as illustrated in FIG. 6 can be used by the seller to manage the customer queue via a web connection or other types of data communication connection, using a web browser, a softphone, an application running on a PDA or cellular phone, or a custom application.

FIG. 6 shows a visual interface for presenting the customers. Alternatively, the seller may dial the phone number assigned to the seller to access the queue of customers via an audio portal. For example, the list of customers may be read to the seller after the seller calls the phone number assigned to the seller from a phone that is associated with the seller.

In one embodiment, the seller can also manage a customer queue via an IVR system over a telephone connection. For example, when the seller is connected to the system via a telephone connection, the seller is presented with the customer queue. The seller can selectively reorder the queue, or select one from the queue for connection to the selected customer. In one embodiment, the system priorities the queue according to a set of rules specified by the seller and presents a number of top ranking customers for selection by the customer.

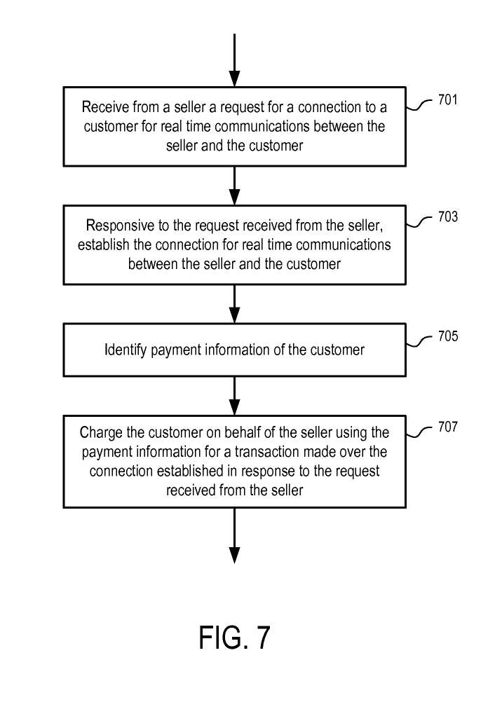

FIG. 7 illustrates a method to connect a seller to a customer in response to a request received from the seller according to one embodiment. In FIG. 7, a request is received (701) from a seller for a connection to a customer for real time communications between the seller and the customer. Responsive to the request received from the seller, the connection for real time communications between the seller and the customer is established (703). Payment information of the customer, such as a credit card number, a debit card number, a bank account number, a member account identifier, etc., is identified (705). On behalf of the seller the customer is charged (707) using the payment information for a transaction made over the connection established in response to the request received from the seller.

In one embodiment, the customer is charged according to a time duration of a service provided by the seller over the connection for real time communications between the seller and the customer established in response to the request received from the seller.

In one embodiment, an indication to charge the customer is received from the seller during the communications between the seller and the customer; and in response to the indication received from the seller, the customer is connected to a human operator to identify the payment information and reconnected back to the seller after the identifying of the payment information.

In one embodiment, the indication is received over the connection for real time communications. For example, the seller may press a key on the phone to request the connection provider to charge the customer. Alternatively, the indication may be received via a separate communication channel (e.g., a selection of a link or icon presented on a call graphics, an email, an SMS, an instant message, etc.). In one embodiment, the customer may press a key on the phone to indicate the starting of a fee-based communication time period. The key may be a hardware switch mounted on the phone, or an icon button selected from a user interface displayed on the phone.

In another embodiment, the customer is connected to an interactive voice responsive system to identify the payment information and reconnected back to the seller after the identifying of the payment information.

In one embodiment, the identifying of the payment information is prior to connecting the customer to the seller. For example, the connection provider may prompt the customer for a member identifier and authenticate the customer before connecting the customer to the seller. In one embodiment, customers provide payment information to the connection provider when establishing membership with the connection provider.

In one embodiment, the establishing of the connection includes: initiating a connection between a connection provider and the customer; and connecting the seller to the connection established between the connection provider and the customer.

In one embodiment, the receiving of the request from the seller includes: establishing a connection between a connection provider and the seller; and receiving an identification of the customer from the seller over the connection between the connection provider and the seller; where the seller is connected from the connection established between the connection provider and the seller to the connection established between the connection provider and the customer. The identification of the customer may be a phone number of the customer, or an identifier assigned by a connection provider to the customer and provided to the seller. In one embodiment, the connection between the connection provider and the customer is established using the phone number of the customer, or the phone number of the customer determined based on the identifier assigned to the customer.

In one embodiment, the connection for real time communications includes an instant messaging connection supporting chat in one or more of text, voice and video.

In one embodiment, the connection for real time communications includes a telephone connection for a telephone conversation. The telephone connection can be established via a connection server establishing a first Voice over Internet Protocol (VoIP) connection with a telecommunication carrier which bridges the first VoIP connection to a public switched telephone network (PSTN) to the seller; and To establish the connection for real time communications between the seller and the customer, the connection server may place a second Voice over Internet Protocol (VoIP) call to a telecommunication carrier which bridges the second VoIP call to a public switched telephone network (PSTN) to the customer and connect the first VoIP connection with the second VoIP call.

In one embodiment, a first virtual softphone terminates the first VoIP connection for bridging onto a public switched telephone network (PSTN); a second virtual softphone terminates the second VoIP call for bridging onto a public switched telephone network (PSTN); and the connection server directs the first softphone and the second softphone to establish a direct media connection, which does not go through the connection server, to connect the seller and the customer.

In another embodiment, the user terminals used by the seller and the customer make peer to peer connection without going through a centralized connection server. The user terminals may be softphones implemented at least in part via software, or software applications or hardware apparatuses for real time communications in text, voice and/or video. In one embodiment, the user terminals report the communication connection to a server to process payment. In one embodiment, the user terminals identify the communication connection in a call signaling message for the communication connection, or a message for set up the communication connection, or a message to resolve a communication reference of the customer to facilitate the communication connection. In another embodiment, the user terminals process at least part of the payment over the peer to peer connection.

In one embodiment, the seller is connected to the customer via a peer to peer connection without going through a centralized connection provider. For example, the seller may use a softphone to call the softphone of the customer. A softphone can be implemented at least in part via software, such as an instant messenger, a VoIP client application running on a computer, an applet embedded in a web page, a built-in or plug-in module of a web browser, a handheld device, a personal digital assistant (PDA), a cellular phone, a cordless phone, a Bluetooth phone, a WiFi phone, etc. The telephonic apparatus used by the seller or the customer may be designed to make a connection based on Internet Protocol, based on a peer to peer network, based on software, and/or based on a connection to a server or a host computer, etc. In some embodiments, the telephonic apparatus can be implemented via hardwire circuitry, such Application-Specific Integrated Circuit (ASIC); in some embodiments, the telephonic apparatus is implemented partially via special purpose hardwire circuitry and partially via software, such as Application-Specific Integrated Circuit (ASIC) or Field-Programmable Gate Array (FPGA) with software/firmware; and in some embodiments, the telephonic apparatus are implemented using a set of general purpose hardwire components that are under the control of software.

In one embodiment, a list of customers who are interested in real time communications with the seller are presented to the seller; and the request received from the seller includes a selection of the customer from the list of customers.

In one embodiment, to establish the connection between the seller and the customer, a connection provider initiates a connection to the seller and a connection to the customer, in response to the selection of the customer; and the connection to the seller and the connection to the customer are bridged to connect the seller and the customer.

In one embodiment, a telephonic reference is assigned to the customer and presented to the seller; the seller uses the telephonic reference to call the connection provider to indicate the request for a connection to the customer. For example, the customer can be identified based on the telephonic reference used by the seller to make the telephone call; and a separate telephone call can be placed to the customer and bridged with the telephone call received from the seller to connect the seller and the customer for real time communications.

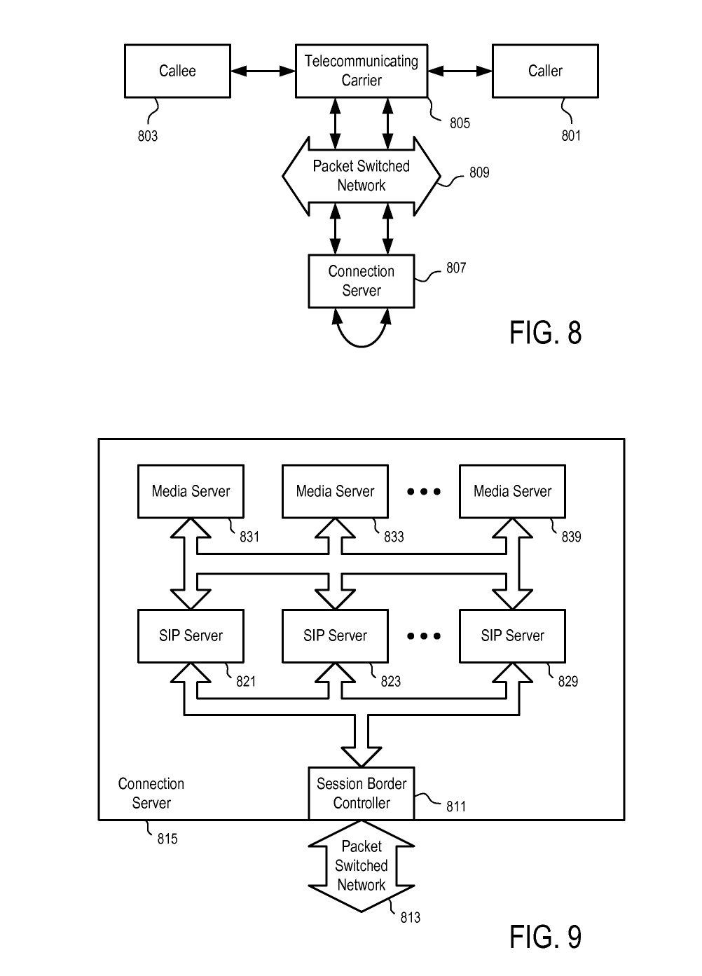

In one embodiment, a connection provider uses a connection server configured on a packet switched network to provide telephone connections between callers (e.g., sellers) and callees (e.g., customers), as illustrated in FIG. 8. In FIG. 8, the connection server (807) receives and/or places telephone calls via the telecommunication carrier (805) over the packet switched network (809). The telecommunication carrier (805) further routes the telephone communications towards the caller (801) and the callee (803).

Since the telecommunication carrier (805) can route a call from a packet switched network to a variety of destinations (e.g., a traditional analog telephone set, a mobile phone, a cellular phone, a WiFi phone, a Bluetooth phone, a softphone running on a computer, etc.), the connection sever (807) can use one type of communication connection with the telephone carrier (805) to facilitate the communication connections with variety of devices used by the customers (e.g., callers and callees). Thus, the implementation of the connection server (807) can be simplified. In one embodiment, the connection server (807) can also place and/or receive direct VoIP calls to/from the caller (or callee).

For example, to make a voice connection in response to a click-to-call request, the connection server can place separate VoIP calls, via the telecommunication carrier (805), to the caller (801) (e.g., the requester of the click-to-call) and the callee (803) (e.g., the destination of the click-to-call request).

If the caller (801) (or the callee 803) is on a public switched telephone network (PSTN), the telecommunication carrier (805) bridges the packet switched the network and the public switched telephone network (PSTN). The telecommunication carrier (805) routes the call from the packet switched network (809) to the caller (801) (or the callee 803) on the circuit switched network. Thus, the caller (801) (or the callee 803) can use a telephone set to receive the call via a Plain Old Telephone Service (POTS). The connection server (807) joins the separate calls that are placed via the packet switched network (809) to connect the callee (803) and the caller (801).

In one embodiment, call signaling and media content may use different network paths. While call signaling is arranged to go through the packet switched network (809) and the connection server (807), the media stream does not have to go through the connection server (807). For example, when the calls are joined, the media content may be redirected to flow over the communication carrier (805) without going through the packet switched network (809) to the connection server (807) for improved performance and efficiency. The connection server (807) can release the control over the media stream to allow the media stream to flow through the shortest path, without going through the connection server, while maintaining control to the connection for the call by staying on the path for call signaling.

In another example, when the caller (801) initiates a call over a PSTN to the connection server (807), the telecommunication carrier (805) converts the call for the packet switched network (809) for the connection server (807).

In one embodiment, virtual softphones on the telecommunication carrier (805) are assigned to the caller (801) and the callee (803) for interfacing with the connection server (807) over the packet switched network (809). The virtual softphones encapsulates the devices and networks used by the caller (801) and callee (803) to access the connection server (807); and the telecommunication carrier (805) shields the connection server (807) from the implementation details of the user devices and networks used by the caller (801) and the callee (803). The connection server (807) calls (or receives calls from) and connects the virtual softphones on the telecommunication carrier (805) to connect the caller (801) and the callee (803).

In FIG. 8, the telephone connection between the telecommunication carrier (805) and the connection server (807) is facilitated via a packet switched network (809). Thus, the connection server (807) can operate efficiently in a digital domain. The connection server (807) interfaces with the telecommunication carrier (805) using one type of Internet Telephony systems (e.g., SIP-based Internet telephony).

Alternatively, a connection server may include some or all of the functionality of the telecommunication carrier (805). For example, the connection server may be configured to bridge a packet switched network and a circuit switched network. The connection server may support multiple, different types of Internet Telephony systems.

In one embodiment, the connection server (807) and the telecommunication carrier (805) are operated by different, separate entities. Alternatively, the connection server (807) and the telecommunication carrier (805) may be operated by the same entity. In another embodiment, the telecommunication carrier (805) includes a set of facilities operated by a number of separate entities.

In one embodiment, the caller (801) and/or the callee (803) may also place/receive calls via a packet switched network. The telecommunication carrier (805) may route the calls between the caller (801) and the callee (803) without using a PSTN. In one embodiment, caller (801) and/or the callee (803) may place calls to or receive calls from the connection server (807) via Internet.

FIG. 9 shows a connection server according to one embodiment. In FIG. 9, the connection server (815) is configured to place and/or receive VoIP calls using Session Initiation Protocol (SIP). A session border controller (811) is used to interface with the packet switched network (813) and control the types of network traffic related to VoIP calls that might go into the connection server (815).

In one embodiment, the session border controller (811) is configured to control the signaling and media stream during the setting up, conducting and tearing down of VoIP calls to or from the connection server (815). In some embodiments, the session border controller (811) may pick up the call that comes to the session border controller (811), places a separate call from the session border controller (811), and joins the received call and the placed call to control both the signaling and media stream. In some embodiments, the session border controller (811) may perform signaling/encoding translation to allow the connection server (815) to process the VoIP calls in one standard, while receiving VoIP calls in a variety of standards (e.g., SIP, H.323, etc.). In one embodiment, the session border controller (811) is configured to perform one or more firewall functionalities, such as denial of service protection, call filtering, bandwidth management, etc.

In one embodiment, the session border controller (811) is configured to perform media releasing operation. When the session border controller (811) determines that the source and destination of a media stream is on the same side of the session border controller (811) (e.g., both the source and the destination of the media stream is outside the connection server 815), the session border controller (811) can release the hairpinning of the media stream and allow the media stream to flow without going through the session border controller (811).

In FIG. 9, a set of SIP servers (e.g., 821, 823, . . . , 829) are networked to the session border controller (811) to receive messages for incoming calls and to initiate outgoing calls. The session border controller (811) is configured to evenly distribute the calls for processing by the SIP servers.

For example, when an incoming message for the initiation of a call is received (e.g., a SIP INVITE message from the telecommunication carrier 805), the session border controller (811) may route it to a SIP server (e.g., 821) for processing. The INVITE message includes the phone number dialed by the caller and the contact information about the caller (e.g., the phone number of the caller 801 and/or the identity of the virtual SIP phone at the telecommunication carrier 805).

The SIP server may determine whether the phone number dialed by the caller (803) is sufficient to determine the phone number of the callee (e.g., 803). If the phone number of the callee (e.g., 803) can be determined from the phone number dialed by the caller (803) (e.g., via decoding the phone number dialed by the callee, or looking up the phone number of the callee from a table using the phone number dialed by the caller as a key), the SIP server can place a separate SIP call to the callee via the packet switched network (813) and then connect the caller and the callee. Alternatively, the SIP server can further route the SIP INVITE message (e.g., to the telecommunication carrier (805) to direct the call to the callee. For example, the SIP server may modify the INVITE message by replacing the destination with the determined phone number of the callee. Further, the SIP server can modify the INVITE message by removing the phone number of the caller (or replacing the phone number of the caller with a phone number of the connection server). In one embodiment, the modified INVITE message identifies the virtual softphone corresponding to the caller on the telecommunication carrier as the SIP phone initiated the call; thus, the virtual softphone corresponding to the callee on the telecommunication carrier can establish media connection with the virtual softphone corresponding to the caller on the telecommunication carrier directly. Alternatively, the modified INVITE message may identify a media server (831) (or a virtual softphone on SIP server) as the initiator for a separate call. The SIP server then connects the calls for the media stream.

In one embodiment, the caller is first connected to a media server (e.g., 831, 833, or 839). For example, the SIP server may forward the SIP INVITE message to one or more of the media servers for answering the call. When a media server (e.g., 831) answers the call, a prompt is played to the caller by the media server. The media server may include an Interactive Voice Response (IVR) system, or be connected to an IVR system, to obtain input from the caller.

For example, the media server may prompt the caller to enter the extension assigned to the callee, such that the phone number of the callee can be determined based on the phone number including the extension dialed by the caller. In some embodiments, the extension dialed by the caller is sufficient to determine the phone number of the callee. After the phone number of the callee is determined, the SIP server can further connect the call to the callee.

For example, the media server can send a message to the SIP server. The message identifies the call and the extension obtained from the caller. The SIP server then determines the callee's phone number based at least on the extension received from the media server and initiates a SIP call via the packet switched network (813) (e.g., by sending a SIP INVITE message to the telecommunication carrier 805, which further bridges the call to the callee 803). Then, the SIP server disconnects the media server from the call and reconnects the call to the callee.

For example, the SIP server can send a SIP BYE message to the media server to disconnect the media server from the call (e.g., by sending a “BYE” message to the media server for the call) and send a re-INVITE message towards the caller to connect the caller and the callee. Alternatively, the media server may send a SIP BYE message to the SIP server for the call; the BYE message may include the extension obtained from the caller; in response to the BYE message that contains the extension, the SIP server determines the phone number of the callee and further connects the caller to the callee.

In one embodiment, the SIP server can direct the caller and the callee to connect to each other for the media stream without having the media stream going through the session border controller (811) into the connection server (815). For example, the media stream can go through the telecommunication carrier (805) in FIG. 8 without going to the connection server (807) after the SIP server connects the caller and the callee.

However, the SIP server stays on the signaling path to monitor the progress and termination of the call. The SIP server can also break the connection between the caller and the callee, or force the media stream to come through the connection serve (815). For example, the SIP server may selectively conference a media server into the call to monitor and/or record the communication of the call between the caller and the callee. For example, the SIP server may reconnect the caller and the callee to separate media servers for interaction with an IVR system or a human operator to confirm a deal or transaction.

Similarly, the SIP server may initiate a callback to a caller via a SIP call over the packet switched network (813) for a connection to the caller. The SIP call may be bridged onto a circuit switched network (e.g., by a telecommunication carrier 805). The SIP server can then reconnect the call to a media server for sending a prompt to the caller before reconnect the call to the callee. Alternatively, the callback can be initiated from a media server; and the call signaling (e.g., the INVITE message from the media server) goes through the SIP server for call control. Alternatively, the SIP server sends out the INVITE message on behalf of the media server.

In one embodiment, the SIP servers (821, 823, 829) and media servers (831, 833, . . . , 839) are implemented on separate computers connected via a local area network (and/or intranet or Internet). Alternatively, at least the some of the servers can be implemented on a same computer. In one embodiment, the SIP servers and the media servers are also integrated with the session border controller (811) on a same data process system having multiple processors coupled with a data bus. In one embodiment, the SIP servers are coupled to the media servers via a network; and a SIP server may use any of the available media server for interaction with the caller (or callee). Alternatively, a SIP server may be configured to use one or more of media servers that are not shared by other SIP server. For example, a SIP server may be implemented on a same data processing system with one or more media servers which are reserved for the SIP server.

In one embodiment, the connection server (815) may further include a database server (815) to storing records related to the calls, data mapping between the communication references assigned to the callees and the actual phone numbers of the callees, etc. In one embodiment, contact mapping are cached in the local memory (e.g., RAM) of the servers for improved performance; and the cached mapping is updated when the database is updated.

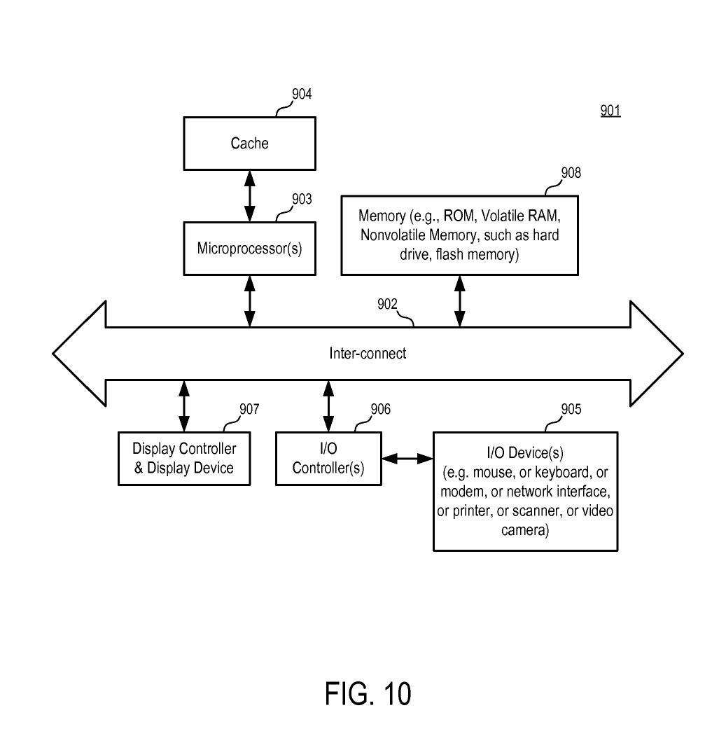

FIG. 10 shows a data processing system according to one embodiment. While FIG. 10 illustrates various components of a computer system, it is not intended to represent any particular architecture or manner of interconnecting the components. Other systems that have fewer or more components may also be used.

In FIG. 10, the communication device (901) is a form of a data processing system. The system (901) includes an inter-connect (902) (e.g., bus and system core logic), which interconnects a microprocessor(s) (903) and memory (908). The microprocessor (903) is coupled to cache memory (904) in the example of FIG. 10.

The inter-connect (902) interconnects the microprocessor(s) (903) and the memory (908) together and also interconnects them to a display controller and display device (907) and to peripheral devices such as input/output (I/O) devices (905) through an input/output controller(s) (906). Typical I/O devices include mice, keyboards, modems, network interfaces, printers, scanners, video cameras and other devices which are well known in the art.

The inter-connect (902) may include one or more buses connected to one another through various bridges, controllers and/or adapters. In one embodiment the I/O controller (906) includes a USB (Universal Serial Bus) adapter for controlling USB peripherals, and/or an IEEE-1394 bus adapter for controlling IEEE-1394 peripherals.

The memory (908) may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a server data processing system as illustrated in FIG. 10 is used as one of the communication server(s), connection server(s), database server(s), media server(s), controller(s), router(s), gateway(s), etc. In some embodiments, one or more servers of the system can be replaced with the service of a peer to peer network of a plurality of data processing systems, or a network of distributed computing system. The peer to peer network, or a distributed computing system, can be collectively viewed as a server data processing system.

A user terminal as a client system can be a data processing system similar to the system of FIG. 10. A client system can be in the form of a PDA, a cellular phone, a notebook computer or a personal desktop computer. For example, the I/O devices of the user device may include a USB phone, a Bluetooth wireless phone, or one or more speakers or headphones with one or microphones for the implementation of a software based phone.

In one embodiment, a user devices/phones support one or more real time communication capabilities, such as VoIP using Session Initiation Protocol (SIP) which may support video and instant-messaging applications, IP phone, regular phone over VoIP service, Bluetooth wireless phone, USB phone, software based phone, and other forms of IP telephony. Other types of traditional communication client(s) may be used in some embodiments.

From this description, it will be appreciated that certain aspects are embodied in the user devices, certain aspects are embodied in the server systems, and certain aspects are embodied in a system as a whole. Embodiments disclosed can be implemented using hardware, programs of instruction, or combinations of hardware and programs of instructions.

In general, routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Aspects disclosed may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry may be used in combination with software instructions to implement the techniques. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system, comprising:
a session border controller to interface with a packet switched network; and
one or more servers coupled to the session border controller to receive from a seller a request for a connection to a customer for real time communications between the seller and the customer, to establish the connection for real time communications between the seller and the customer in response to the request received from the seller, to identify payment information of the customer, and to charge the customer on behalf of the seller using the payment information for a transaction made over the connection established in response to the request received from the seller.

2. A method, comprising:
receiving from a seller a request for a connection to a customer for real time communications between the seller and the customer;
responsive to the request received from the seller, establishing the connection for real time communications between the seller and the customer;
identifying payment information of the customer; and
charging the customer on behalf of the seller using the payment information for a transaction made over the connection established in response to the request received from the seller.

3. The method of claim 2, wherein the customer is charged according to a time duration of a service provided by the seller over the connection for real time communications between the seller and the customer established in response to the request received from the seller.

4. The method of claim 2, wherein the customer is charged an amount independent of a time duration of a service provided by the seller over the connection for real time communications between the seller and the customer established in response to the request received from the seller.

5. The method of claim 2, further comprising:
receiving from the seller an indication to charge the customer; and
in response to the indication received from the seller, connecting the customer to a human operator or an interactive voice response (IVR) system to identify the payment information and reconnecting the customer back to the seller after the identifying of the payment information.

6. The method of claim 2, wherein the connection established in response to the request received from the seller comprises a peer to peer connection.

7. The method of claim 2, wherein the identifying of the payment information is prior to connecting the customer to the seller.

8. The method of claim 2, wherein the establishing of the connection comprises:
initiating a connection between a connection provider and the customer; and
connecting the seller to the connection established between the connection provider and the customer.

9. The method of claim 8, wherein the receiving of the request from the seller comprises:
establishing a connection between a connection provider and the seller; and
receiving an identification of the customer from the seller over the connection between the connection provider and the seller;
wherein the seller is connected from the connection established between the connection provider and the seller to the connection established between the connection provider and the customer.

10. The method of claim 9, wherein the identification of the customer comprises a phone number of the customer, or an identifier assigned by a connection provider to the customer and provided to the seller.

11. The method of claim 10, wherein the connection between the connection provider and the customer is established using the phone number of the customer, or the phone number of the customer determined based on the identifier assigned to the customer.

12. The method of claim 2, wherein the connection for real time communications comprises an instant messaging connection supporting chat in one or more of text, voice and video.

13. The method of claim 2, wherein the connection for real time communications comprises a telephone connection for a telephone conversation.

14. The method of claim 13, wherein the telephone connection is established via a connection server establishing a first Voice over Internet Protocol (VoIP) connection with a telecommunication carrier which bridges the first VoIP connection to a public switched telephone network (PSTN) to the seller; and
wherein the establishing of the connection for real time communications between the seller and the customer comprises the connection server placing a second Voice over Internet Protocol (VoIP) call to a telecommunication carrier which bridges the second VoIP call to a public switched telephone network (PSTN) to the customer and connecting the first VoIP connection with the second VoIP call.

15. The method of claim 14, wherein a first virtual softphone terminates the first VoIP connection for bridging onto a public switched telephone network (PSTN); a second virtual softphone terminates the second VoIP call for bridging onto a public switched telephone network (PSTN); and the connection server directs the first softphone and the second softphone to establish a direct media connection, which does not go through the connection server, to connect the seller and the customer.

16. The method of claim 2, further comprising:
presenting to the seller a list of customers who are interested in real time communications with the seller; and
wherein the request received from the seller comprises a selection of the customer from the list of customers.

17. The method of claim 16, wherein the establishing of the connection comprises:
a connection provider initiating a connection to the seller in response to the selection of the customer;
the connection provider initiating a connection to the customer; and
bridging the connection to the seller and the connection to the customer to connect the seller and the customer.

18. The method of claim 2, further comprising:
assigning a telephonic reference to the customer; and
presenting to the seller the telephonic reference assigned to the customer;
wherein the receiving of the request from the seller comprises receiving a telephone call via the telephonic reference.

19. The method of claim 18, further comprising:
identifying the customer based on the telephonic reference used by the seller to make the telephone call; and
placing a separate telephone call to the customer;
wherein the establishing of the connection for real time communications between the seller and the customer comprises bridging the telephone call received from the seller and the separate telephone call placed to the customer.

20. A machine readable media embodying instructions, the instructions causing a machine to perform a method, the method comprising:
receiving from a seller a request for a connection to a customer for real time communications between the seller and the customer;
responsive to the request received from the seller, establishing the connection for real time communications between the seller and the customer;
identifying payment information of the customer; and
charging the customer on behalf of the seller using the payment information for a transaction made over the connection established in response to the request received from the seller.
